(19) United States
(12) Patent Application Publication
(10) Pub. No.: US 2008/0235095 A1
(43) Pub. Date: Sep. 25, 2008

(54) Gift card kiosk

(75) Inventors: David Oles, San Marcos, TX (US); John Johnson, San Marcos, TX (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: DNP Photo Imaging America Corporation, San Marcos, TX (US)

(21) Appl. No.: 12/077,431

(22) Filed: Mar. 19, 2008

Related U.S. Application Data
(60) Provisional application No. 60/918,799, filed on Mar. 19, 2007.

(51) Int. Cl. G06Q 30/00

(52) U.S. Cl. 705/14

(57) ABSTRACT

A gift card kiosk is disclosed providing a method for selecting, customizing, and dispensing gift cards utilizing information provided by a purchaser about the intended recipient of the gift card in order to find the gift card with the most appropriate content and from the most appropriate retailer. A purchaser may customize the gift card with their own personalized message, picture, or other information. The gift card kiosk provides for the production of such customized gift cards from gift card blanks stored within the kiosk that are printed with appropriate information on demand, and are likewise activated by the kiosk through management of a listing and assignment of gift card activation numbers.

### CROSS-REFERENCE TO RELATED APPLICATIONS

This application is based upon and claims benefit of co-pending and co-owned U.S. Provisional Patent Application Ser. No. 60/918,799 entitled “GIFT CARD KIOSK,” filed with the U.S. Patent and Trademark Office on Mar. 19, 2007 by the inventors herein, the specification of which is incorporated herein by reference in its entirety.

### BACKGROUND OF THE INVENTION

1. Field of the Invention

The present invention relates to the field of card dispensers, and more particularly to a machine and method of dispensing customized gift cards.

2. Background

Gift cards are generally displayed in racks at convenience stores and other retail stores. These display racks are bulky and require a substantial amount of space in the store. In some instances, gift cards may be distributed through card dispensers that allow a consumer to purchase a pre-valued and pre-printed card. At other times, the gift card value may be added to the magnetic stripe of the card at the time of purchase. Some other dispensers may allow the consumer to add certain content that is printed onto the card at the time of purchase. However, such card dispenser have traditionally offered the purchaser limited opportunity to exercise creativity in the creation of a customized gift card, and likewise have offered little assistance to purchasers to help them select and customize a gift card so that it might be specifically tailored for the intended recipient of the card.

### SUMMARY OF THE INVENTION

With regard to one aspect of a particularly preferred embodiment of the invention, a method for selecting gift cards is provided. In a first step a database of available gift cards is created. Each gift card is assigned a card attribute that facilitates the selection of the cards by a purchaser. In a subsequent step, the purchaser is allowed to enter recipient attributes, which identify characteristics of the person that will receive the gift card that may be utilized to match the appropriate gift card to the intended recipient. In a further step, the card attributes are compared with the recipient attributes and those cards that best match the recipient attributes are presented to the purchaser for selection. In another embodiment, it is contemplated that retailers may also be categorized by providing retailer attributes, which may be utilized to evaluate and match the retailers best suited to the intended recipient and occasion.

With regard to another aspect of a particularly preferred embodiment, a software program embodied in a computer readable medium contains instructions for selecting gift cards based upon card attributes and recipient attributes. The software program contains instructions for creating a database of available gift cards and assigning card attributes to the cards in the database. The program also contains instructions for requesting information from a purchaser about an intended recipient to create recipient attributes. The program includes further instructions to evaluate the recipient attributes and the card attributes and to present the most appropriate gift cards to the purchaser, and particularly those gift cards that best match the recipient attributes.

With regard to yet another aspect of a particularly preferred embodiment, a system for selecting gift cards is provided. The system includes a gift card kiosk with a data processor that has a software program embodied in a computer readable medium containing instructions for selecting gift cards based upon card attributes and recipient attributes. The software program contains instructions for creating a database of available gift cards and assigning card attributes to the cards in the database. The program also contains instructions for requesting information from a purchaser about an intended recipient to create recipient attributes. The program includes further instructions to evaluate the recipient attributes and the card attributes and present the most appropriate gift cards to the purchaser, and particularly those gift cards that best match the recipient attributes.

Other and additional objects of this invention will become apparent from a consideration of this entire specification.

### BRIEF DESCRIPTION OF THE DRAWINGS

FIG. 1 is a graphical depiction of an exemplary gift card kiosk in accordance with one embodiment of the present invention.

FIG. 2 is a graphical depiction of an exemplary gift card blank.

FIG. 3A is an illustration of an exemplary graphical user interface giving a purchaser options for selecting a gift card.

FIG. 3B is an illustration of an exemplary graphical user interface for a purchaser to select a card by retailer.

FIG. 3C is an illustration of an exemplary graphical user interface for a purchaser to select a retailer with the option to search for the retailer by name.

FIG. 3D is an illustration of an exemplary graphical user interface for a purchaser to select a category.

FIG. 3E is an illustration of an exemplary graphical user interface for a purchaser to select a category with the option to search for the category by name.

FIG. 3F is an illustration of an exemplary graphical user interface for a purchaser to provide information about the intended recipient of the gift card.

FIG. 3G is an illustration of an exemplary graphical user interface for a purchaser to provide information about the intended recipient of the gift card, where the information provided represents the age of the intended recipient.

FIG. 3H is an illustration of an exemplary graphical user interface where the purchaser is presented with options based upon the information entered about the intended recipient.

FIG. 3I is an illustration of an exemplary graphical user interface for a purchaser to provide information about the intended recipient of the gift card, where the information provided represents the gender of the intended recipient.

FIG. 3J is an illustration of an exemplary graphical user interface where the purchaser is presented with options based upon the information entered about the intended recipient.

FIG. 3K is an illustration of an exemplary graphical user interface for a purchaser to provide information about the intended recipient of the gift card, where the information provided represents the gender and age of the intended recipient.

FIG. 3L is an illustration of an exemplary graphical user interface where the purchaser is presented with options based upon the information entered about the intended recipient.

FIG. 4A is an illustration of an exemplary graphical user interface that allows the purchaser to select a value for the gift card.

FIG. 4B is an illustration of an exemplary graphical user interface that allows the purchaser to provide a specified value for the gift card.

FIG. 4C is an illustration of an exemplary graphical user interface that allows the purchaser to review his or her order.

FIG. 5A is an illustration of a standard card template according to an aspect of a particularly preferred embodiment of the invention.

FIGS. 5B-D are illustrations of different types of standard cards in accordance with one embodiment of the invention.

FIG. 5E is an illustration of an exemplary graphical user interface allowing the purchaser to select a specific card from choices that reflect the information provided about the intended recipient of the card.

FIG. 6A is an illustration of an exemplary graphical user interface that provides the purchasers with different choices to personalize their gift cards.

FIG. 6B is an illustration of an exemplary graphical user interface that allows the purchasers to add text to their gift cards.

FIG. 6C is an illustration of an exemplary graphical user interface that allows the purchasers to add pictures to their cards.

FIG. 6D is an illustration of an exemplary graphical user interface that further allows purchasers to select a desired picture from a digital media device.

FIG. 6E is an illustration of an exemplary graphical user interface that further allows the purchasers to modify pictures to be added to a gift card.

FIG. 6F is an illustration of an exemplary graphical user interface that allows the purchasers to add text for personalizing cards.

FIG. 6G is an illustration of a high resolution sample and a sample card with a picture according to one aspect of a particularly preferred embodiment of the invention.

FIG. 6H is an illustration of an exemplary graphical user interface that allows the purchasers to select the occasion related to the gift card to be purchased.

FIG. 6I is an illustration of an exemplary graphical user interface that provides the purchasers with different card options for the occasion selected.

FIG. 6J is an illustration of an exemplary graphical user interface that further allows the purchasers to add text to the cards for specific occasions.

FIG. 7A is an illustration of an exemplary graphical user interface that allows the purchasers to review the gift card order.

FIG. 7B is an illustration of an exemplary graphical user interface that gives the purchasers payment options.

### DETAILED DESCRIPTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

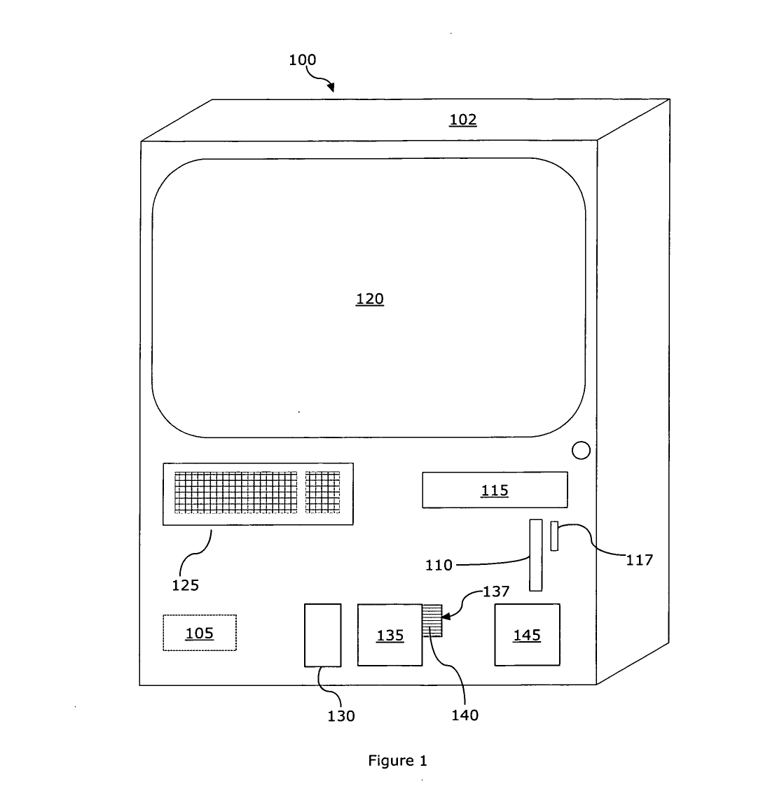

As shown in FIG. 1, a gift card kiosk 100 may be utilized for creating and activating customized gift cards, either accessible to store customers in a retail establishment or placed behind a service counter in a photo lab environment. The gift card kiosk 100 preferably includes a computer processor 105 in communication with preferably at least a flash media reader 110, a CD drive 115 (preferably writeable), a media storage device 117 (connected to the processor 105, for example, through a USB port 118), a touch screen display 120, a computer keyboard 125, a receipt printer 130, an encoder 132, a gift card printer 135, a gift card container 137, gift card blanks 140, and a credit card/cash reader 145. The computer processor 105 may be further connected to a network. Such system components are preferably housed within a kiosk enclosure 102 having a lock requiring a key entry to maintain security of the device, or any other security mechanism recognized by those skilled in the art. It is contemplated that the gift card kiosk 100 may include all of the elements described above or as few of the elements as required to allow a consumer to purchase a customized gift card.

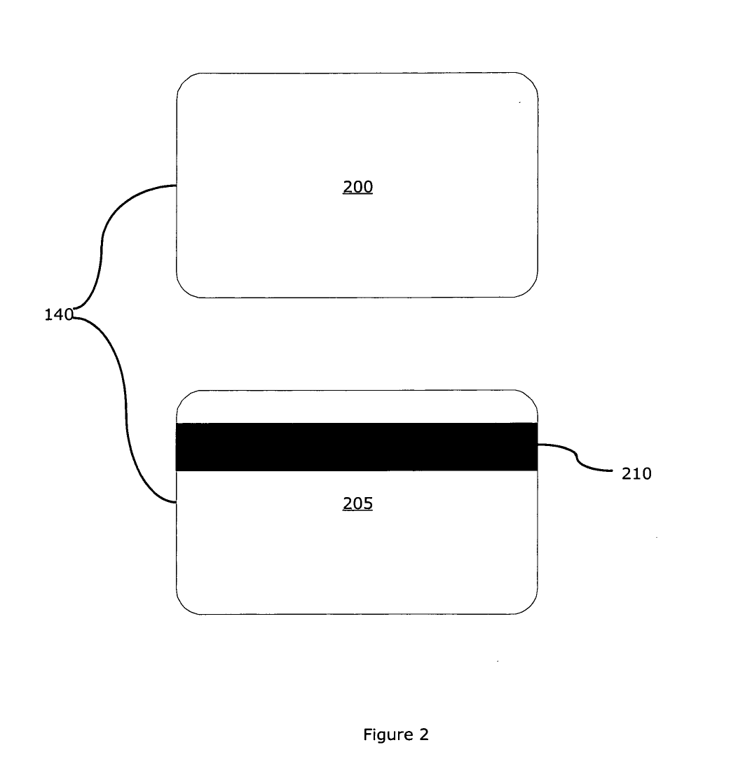

As shown in FIG. 2, the gift card blanks 140 are plastic cards with a front side 200 and a back side 205. On the back side 205, the card includes a magnetic stripe 210. The magnetic stripe 210 is capable of being encoded with appropriate gift card data at the time of purchase. The card blanks 140 are constructed of plastic materials that have the ability of accepting colors and drawings from the gift card printer 135. In a particularly preferred embodiment, the card blanks 140 do not include any identification characteristics (e.g., card identification numbers) because all of the information is to be added to the magnetic stripe 210 at the time of purchase. A user may thus customize a gift card prior to purchase by, for example, customizing the amount associated with each card, customizing text placed on the card, customizing graphics placed on the card, and/or customizing the card for specific occasions (e.g., birthdays, holidays, etc.). Moreover, as the cards are stored in the kiosk as blanks 140, they are not accessible until they are purchased by the intended customer, such that the risk of fraud and theft (e.g., by an ill-intentioned person noting a card identification number and later using that number to make purchases on their own without the knowledge or consent of the person that ultimately purchased such card) is minimized.

The computer processor may preferably include a wizard, which is a computer software program or set of instructions that allows the purchaser to select, customize, pay for and retrieve gift cards from the kiosk 100. The software program embodied in a computer readable medium contains instructions for selecting gift cards based upon card attributes and recipient attributes. The software program contains instructions for creating a database of available gift cards and assigning card attributes to the cards in the database. The program also contains instructions for requesting information from a purchaser about an intended recipient to create recipient attributes. The program includes further instructions to evaluate the recipient attributes and the card attributes and present the most appropriate gift cards to the purchaser, namely, those gift cards that best match the recipient attributes. It is contemplated that retailers may also be categorized by providing retailer attributes, which may be utilized to evaluate and match the retailers best suited to the intended recipient and occasion.

The wizard provides a graphical user interface displayed on the touch screen display 102 that allows the purchaser to search for available cards from specific retailers by category (e.g., entertainment, apparel, leisure and hobby, food and beverage, home, phone cards, cash card, toys, etc.) or by occasion (e.g., Christmas, birthday, congratulations, anniversary, Valentine's Day, graduation, etc.). It is contemplated that in some embodiments, the user may utilize the keyboard 125 (if available) or make the selections directly from the touch screen 120.

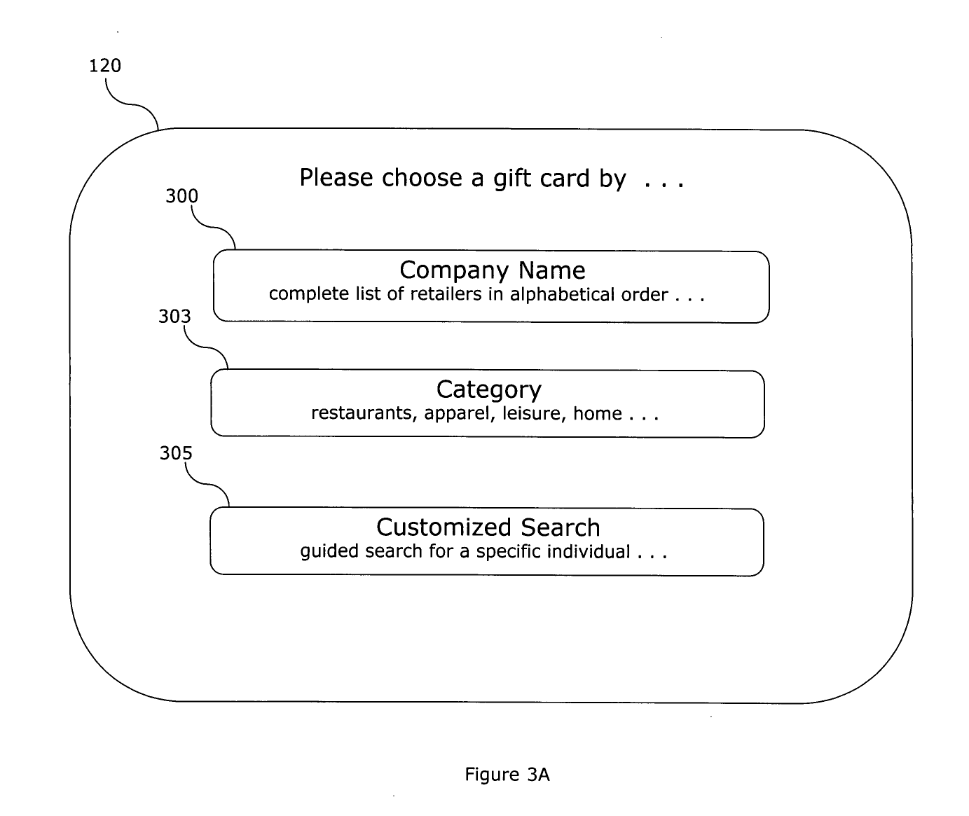

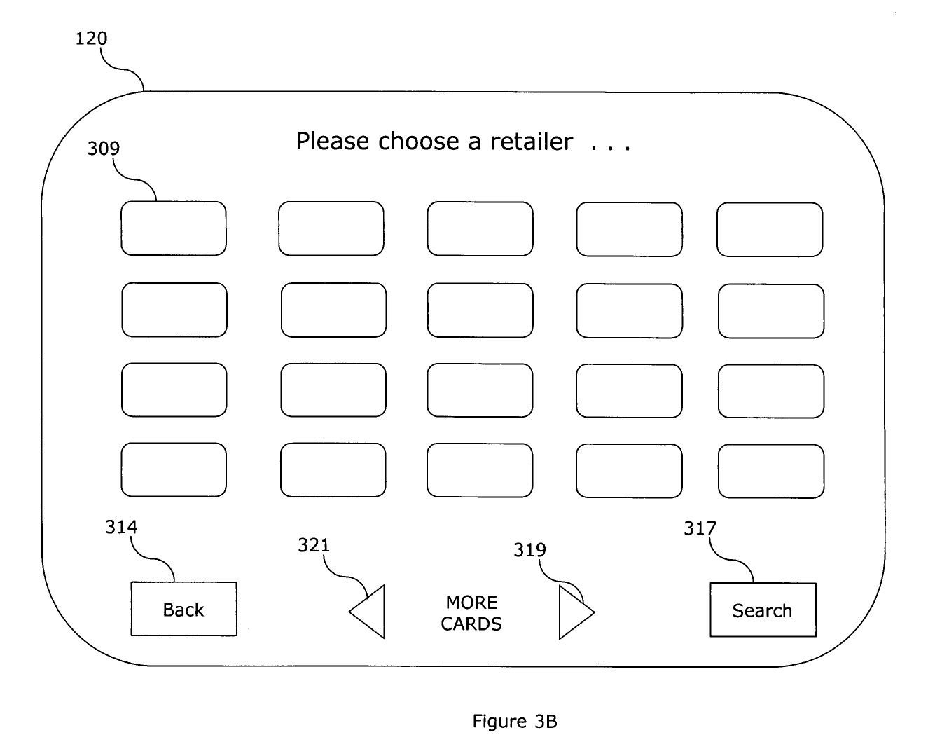

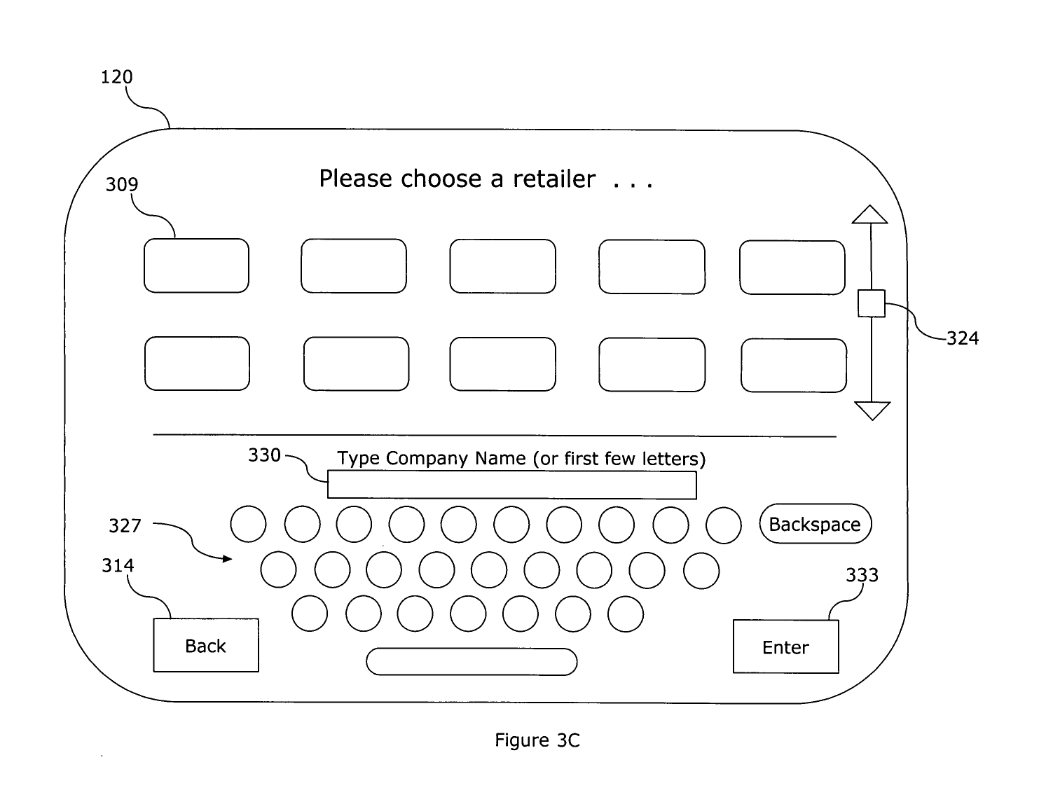

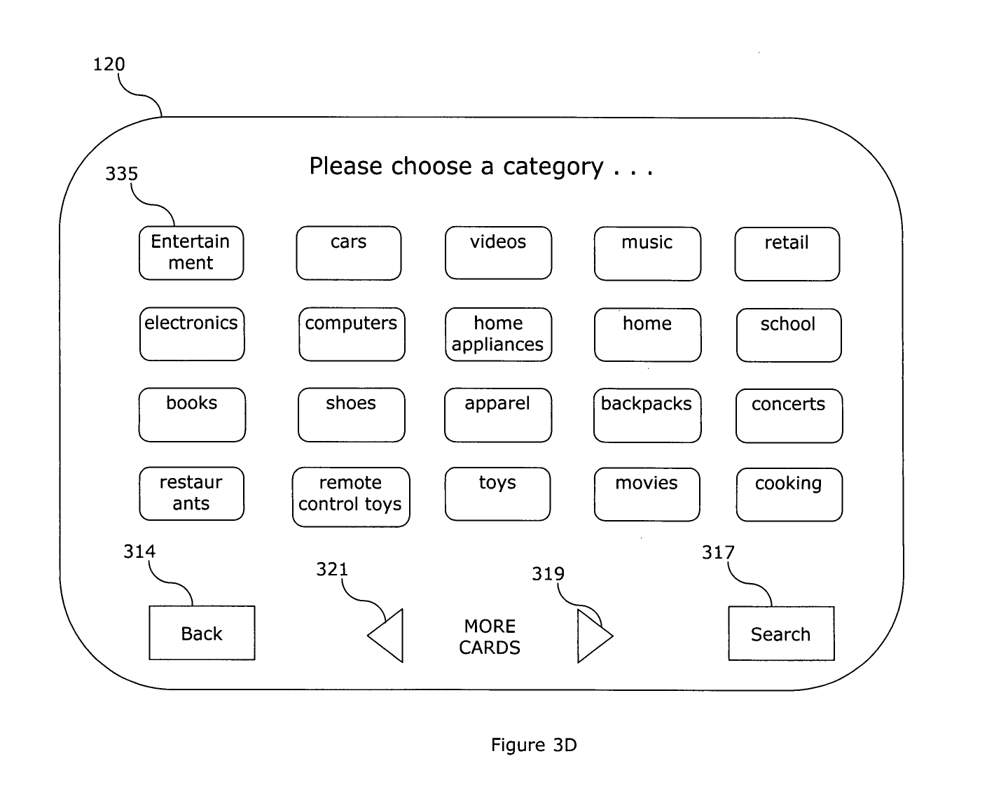

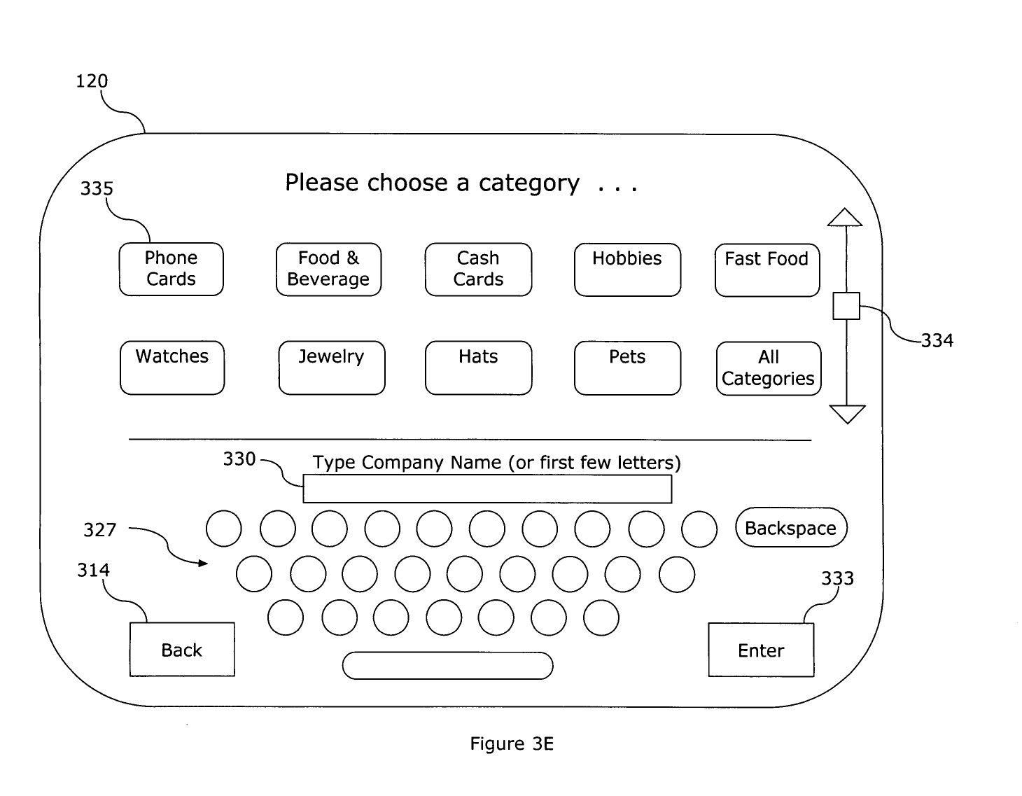

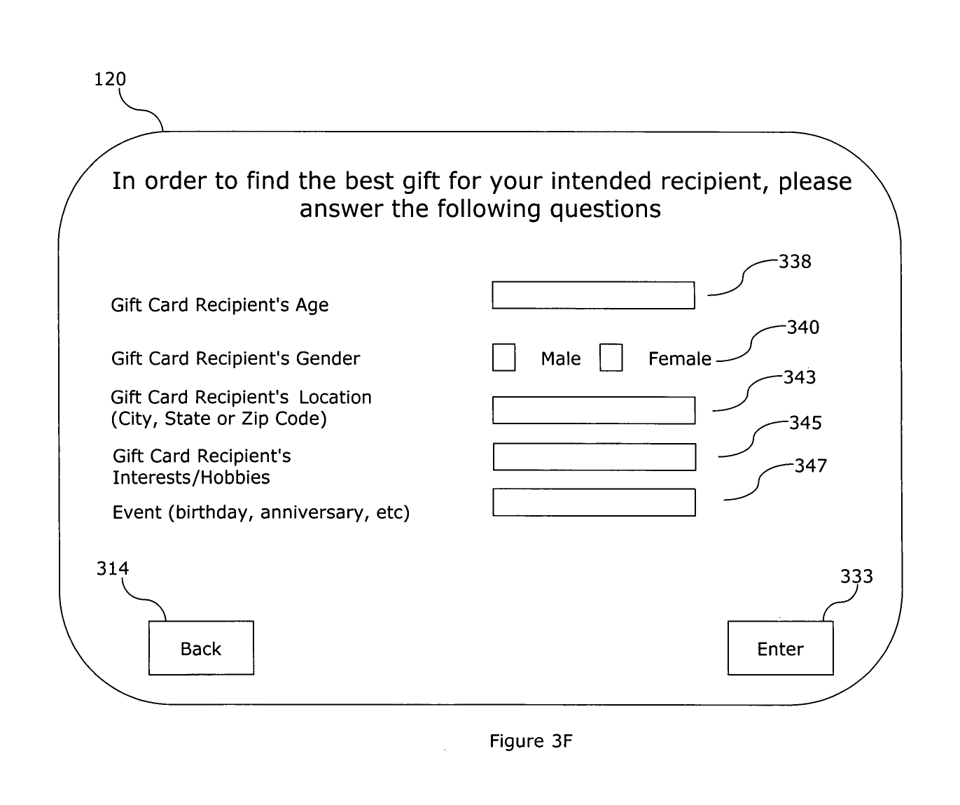

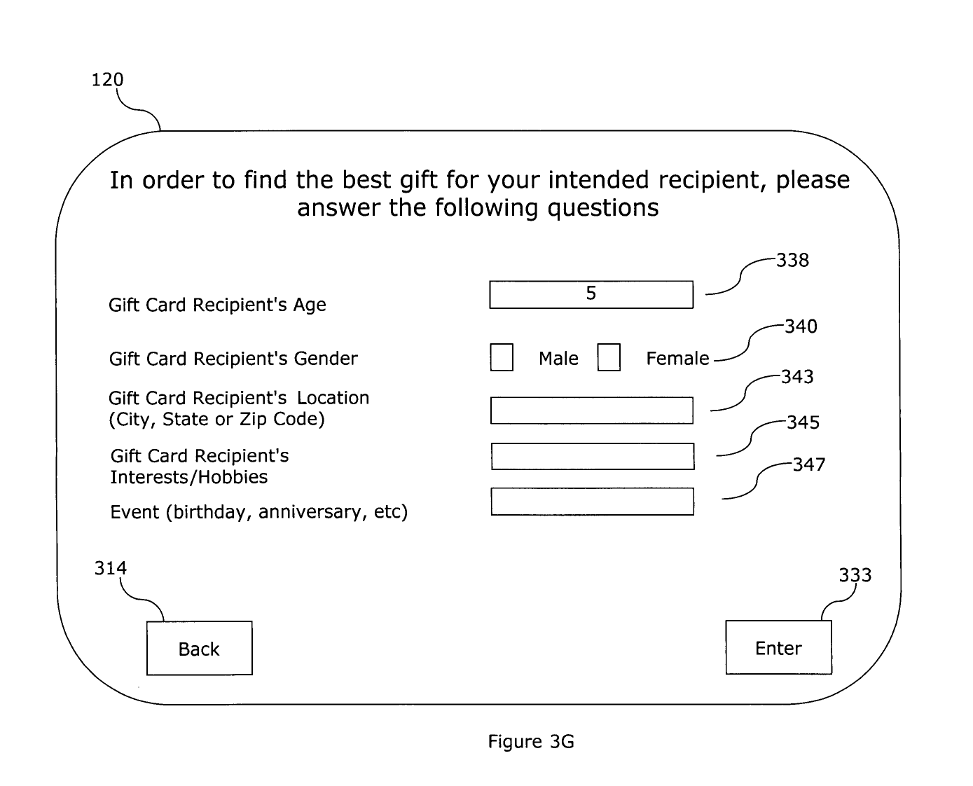

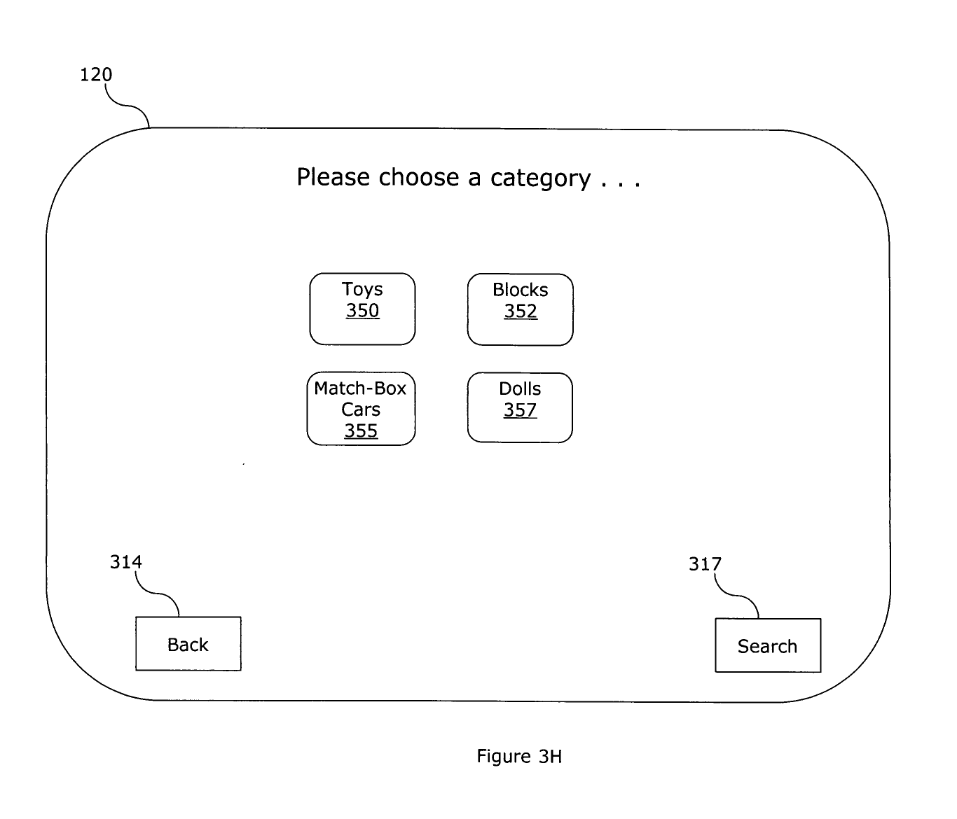

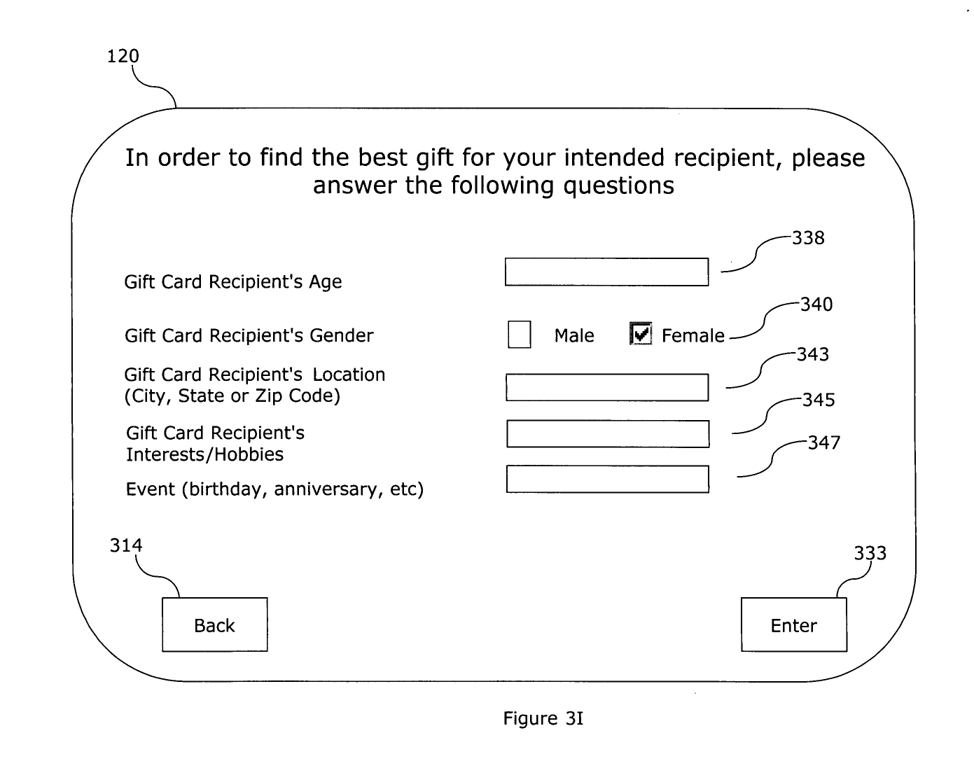

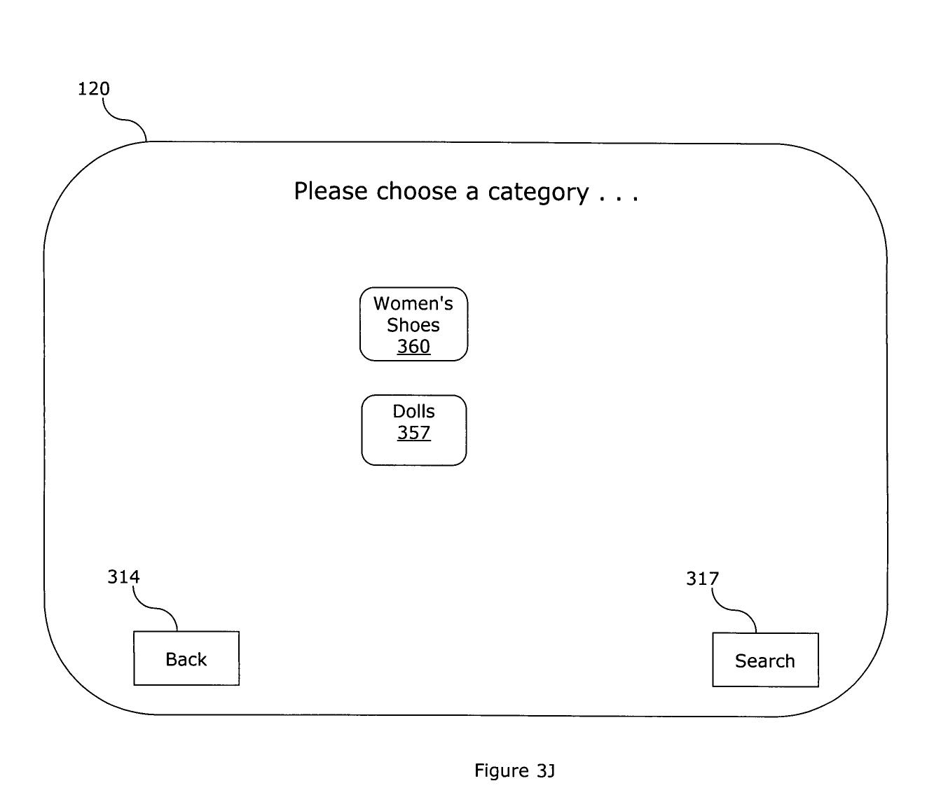

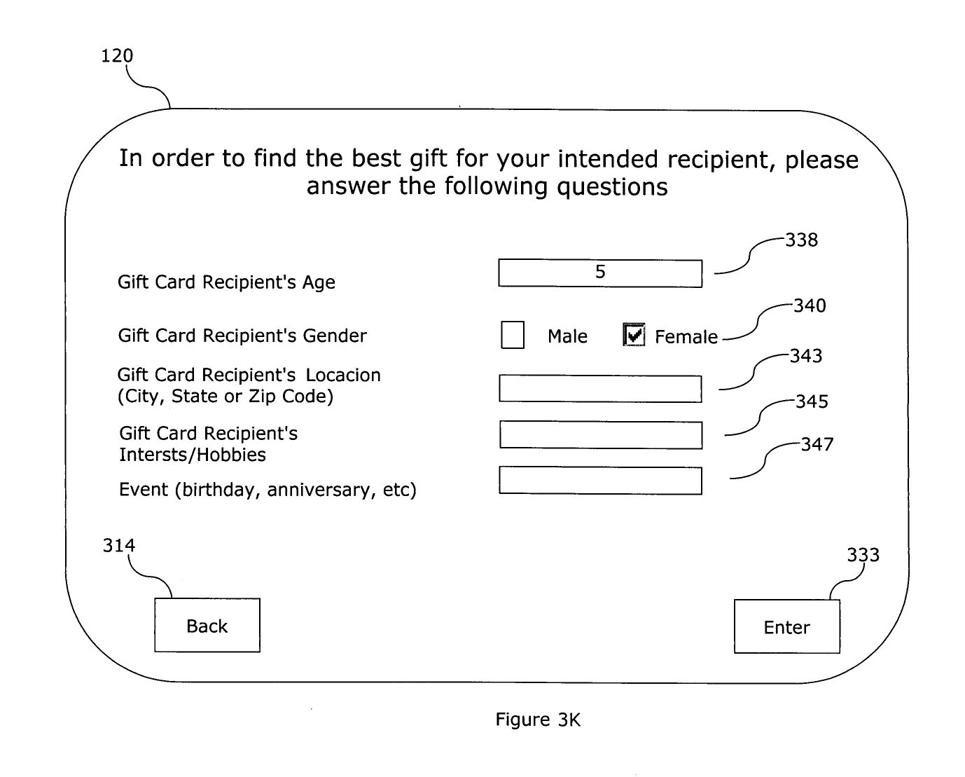

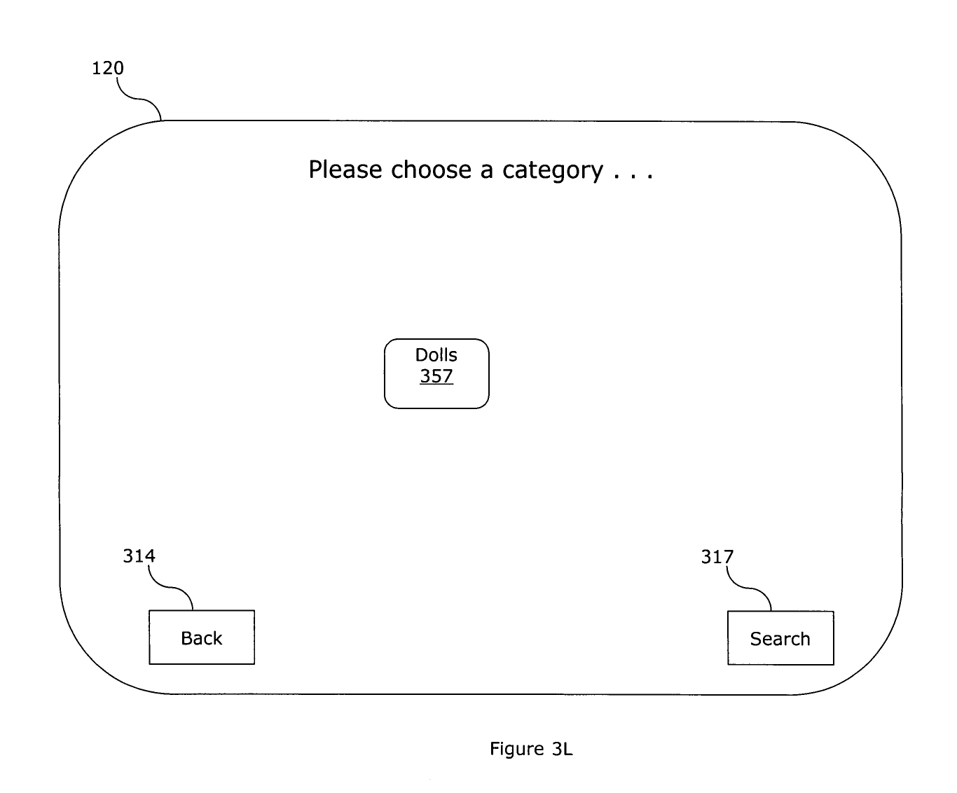

In a preferred embodiment, the wizard provides a first screen to the purchaser as generally shown in FIG. 3A, where the purchaser can select from a company name button 300, a category selection button 303, and a custom button 305. Upon selection of the company name button 300, a listing of the participating retailers may be presented to the purchaser as shown in FIG. 3B. A person of ordinary skill in the art will recognize that the display may include an alphabetical listing of the retailers (listing of the underlined name of the retailer, for example) or a retailer button 309 display of the retailers (such as thumbnails of the retailer's name and logo). The purchaser may also be given the option to select a back button 314 for returning to the previous display or a search button 317 that allows searching for a particular retailer. If there are more retailer buttons 309 than it is possible to display on the screen 120, the purchaser may press the forward button 319 or backward button 321. If the purchaser selects the forward button 319, the new screen shown in FIG. 3C, may provide additional retailer buttons 309 and in some instances a scroll bar 324 that allows the purchaser to move the display in order to show additional retailer buttons 309. The screen may also contain an interactive keyboard 327 and a display window 330. The purchaser may utilize the keyboard 327 to type the name of the retailer. The purchaser's entry may be viewed in the display window 330. As the purchaser is typing the name of the retailer, the display may narrow the retailer buttons 309 being provided to those that meet the purchaser's input. In other embodiments, the chosen retailer may be displayed after the purchaser presses an “enter” button 333.

With regard to a further capability of the wizard, when the purchaser selects the category selection button 303, a listing of the available categories may be presented to the purchaser as shown in FIG. 3D. A person of ordinary skill in the art will recognize that the display may include, for example, an alphabetical listing of the categories (for example, a list of underlined categories) or a category button 335 display of the categories (such as thumbnails with the category and a related graphic). The purchaser may also be given the option to select the back button 314 for returning to the previous display or the search button 317 for a particular category. If there are more categories than it is possible to display on the screen 120, the purchaser may press the forward button 319 or backward button 321. If the purchaser selects the forward button 319, the new screen shown in FIG. 3E, may provide additional category buttons 335 and in some instances a scroll bar 334 that allows the purchaser to move the display in order to display additional category buttons 335. The screen may also contain an interactive keyboard 327 and a display window 330. The purchaser may utilize the keyboard 327 to type the name of the category. The purchaser's entry may be viewed in the display window 330. As the purchaser is typing the name of the category, the display may optionally narrow the category buttons 335 displayed to those that meet the purchaser's input. In other embodiments, the chosen category may be displayed after the purchaser presses an “enter” button 333. When the purchaser selects from the categories presented to him or her, a list of retailers providing the types of goods and services associated with that category is displayed.

Upon selection of the custom button 305, the gift card selection wizard provides a number of questions, corresponding to the recipient attributes, that aid the purchaser in identifying the retailers that may be most appropriate for the intended gift card recipient. As shown in FIG. 3F, the purchaser may be presented with a number of questions, for example age 338, gender 340, location 343, interests 345, event 347, and any other question that may allow the wizard to narrow the number of available categories presented to the consumer. It is contemplated that the consumer may be presented with one or more of the above mentioned questions, and other questions directed to characteristics and/or interests of the intended card recipient to help customize the selection of a gift card for that intended recipient. When the purchaser is presented with all of the questions in the same screen 120, he or she may answer one or more of the questions. Based upon the answers from the purchaser, the wizard presents him or her with the categories that match that particular gift card recipient. For example, as shown in FIG. 3G, if a purchaser only inputs the intended recipient's age (e.g., 5 years old), the user may be presented with those categories that are considered age-appropriate for the intended recipient (e.g., toys 350, blocks 352, match-box cars 355 and dolls 357) as shown in FIG. 3H. If the purchaser only provides the intended recipient's gender, as shown in FIG. 3I, the user may be presented with those categories that may be considered appropriate for such intended recipient's gender, such as dolls 357 and women's shoes 360 as shown in FIG. 3J. If the user enters both the intended recipient's age and gender, the user may be presented with those cards that may be considered most age and gender appropriate. For example, as shown in FIG. 3K, if the user enters age 5 and selects female, the purchaser is presented with the dolls category 357, FIG. 3L. It is also contemplated that if there is only one category that applies to the selections made by the purchaser, the list of appropriate retailers may be displayed directly without the corresponding category button 335 being presented to the purchaser. The same method may be utilized to select the most appropriate content for each gift card. The wizard may present the purchaser with content options for the graphics on the gift card that are most closely related to the gift card recipient as determined from the purchaser's answers to the questions presented.

When the purchaser enters the intended recipient's location (e.g., where they live), the display to the user may provide categories with retailers having a location that is within a predetermined distance from such location. In some embodiments, the purchaser may be given the option to select the predetermined distance from the intended recipient's location. Moreover, the software may request the intended recipient's shopping style, such as a listing of stores where the recipient shops, and display to the user cards for retailers that are similar to one or more of the recipient's preferred shops. Additional categories may likewise be provided to meet the various interests and/or traits of intended recipients.

As explained previously, the software may optionally stage the display of cards depending upon the purchaser's answers by, for instance, presenting one question at a time and narrowing the selection based on the recipient attributes. For example, the wizard may present the purchaser with a question about the gender of the intended recipient. After the purchaser answers, the display may present the retailers for that category and also a question about the intended recipient's age. The purchaser may select a retailer from the selection presented or answer the question. If the purchaser answers the question, the wizard will further narrow the selection by the intended recipient's age, etc. Preferably, each retailer is provided one or more attributes that identify its correlation with each category, such that as the purchaser selects values for each category, a database containing retailer attributes may be consulted to continuously narrow the selection of preferred retailers.

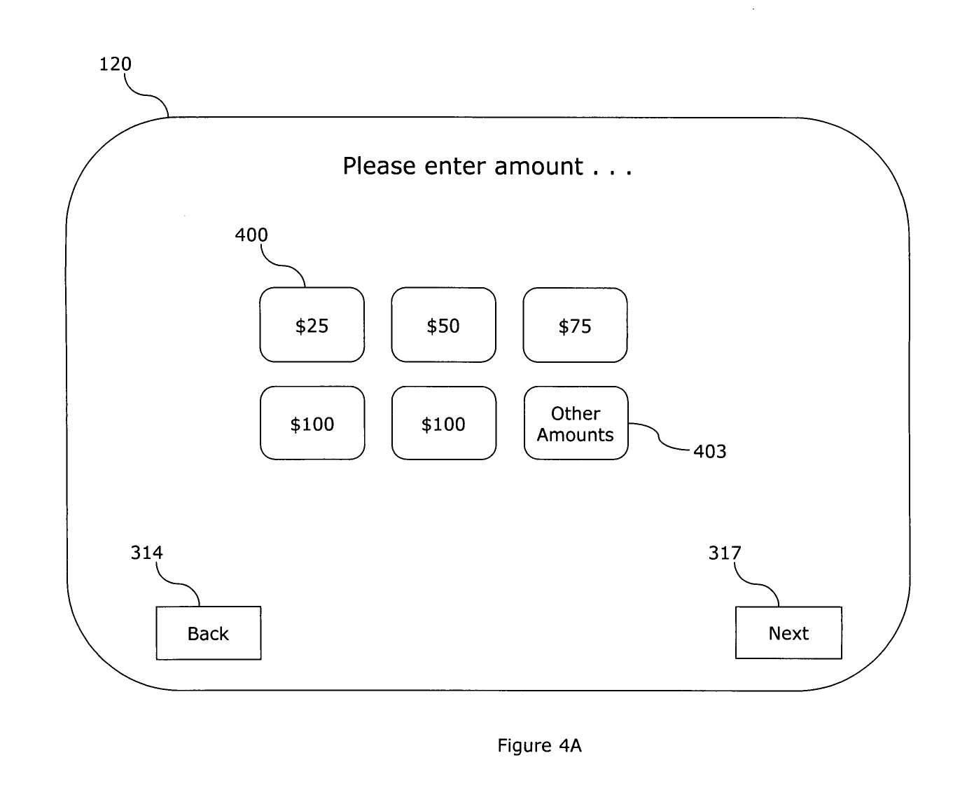

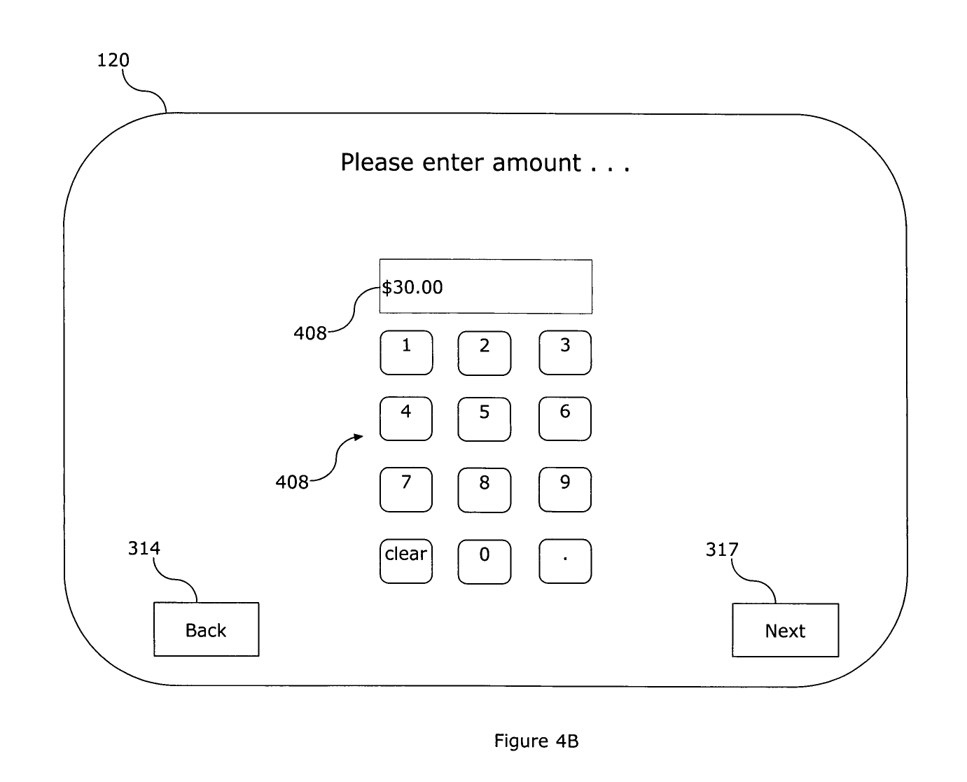

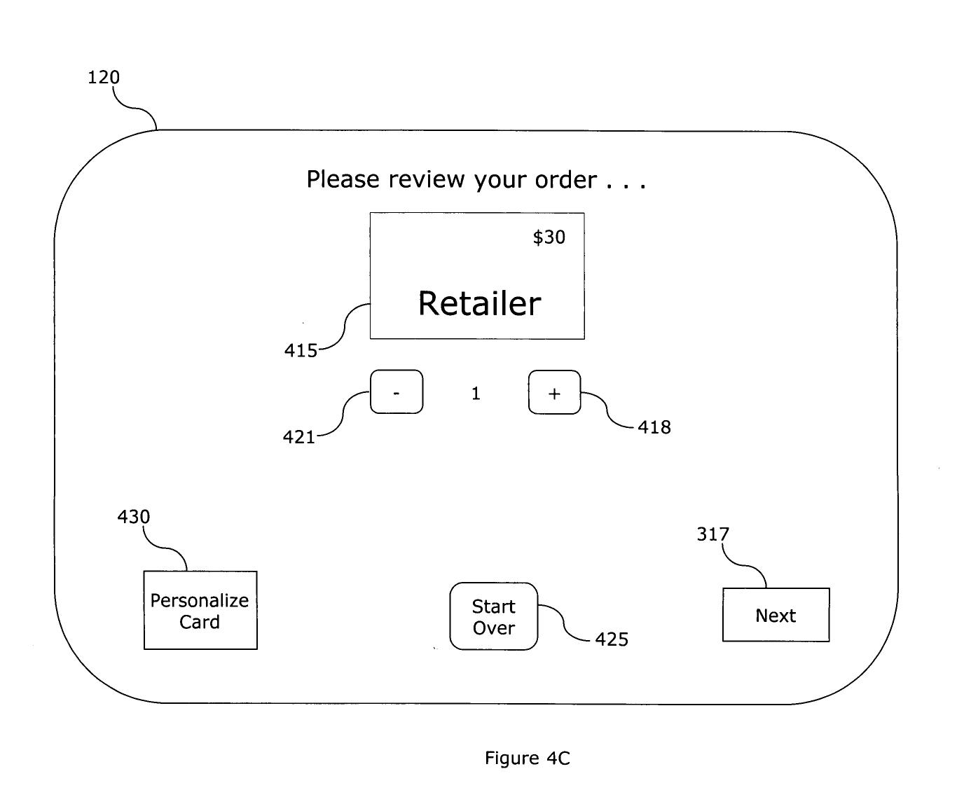

After the purchaser selects the retailer, he or she may select the amount to be added to the gift card. In one exemplary embodiment as shown in FIG. 4A, the purchaser is given a number of different amounts for selection through value buttons 400. Each value button 400 may identify a specific cash amount, e.g., $25, $50, $75, $100, $200. The purchaser may also be presented with an “other amounts” button 403. If the “other amounts” button 403 is selected, the purchaser may be presented with the display shown in FIG. 4B, which includes a value display 406 and a keypad 408. The purchaser may enter the desired value using the keypad 408 and the amount may be displayed in the value window 406. Once the purchaser has entered the desired amount, he or she may press a “next” button 410 to proceed with the transaction.

The next screen presented to the purchaser, as shown in FIG. 4C, displays a generic card sample 415 from the chosen retailer and gives the purchaser a number of options. The purchaser may select a single card or multiple cards by selecting the increase 418 or decrease 421 buttons. The purchaser may also be redirected to the beginning of the process by selecting the “start over” button 425. Furthermore, the purchaser may be given the opportunity to personalize the appearance of the gift card by selecting the “personalize card” button 430 or continue to the next 317 screen.

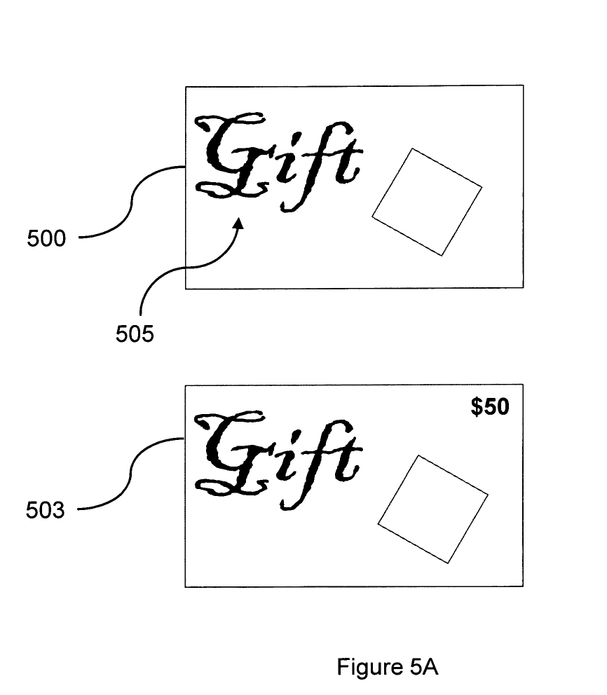

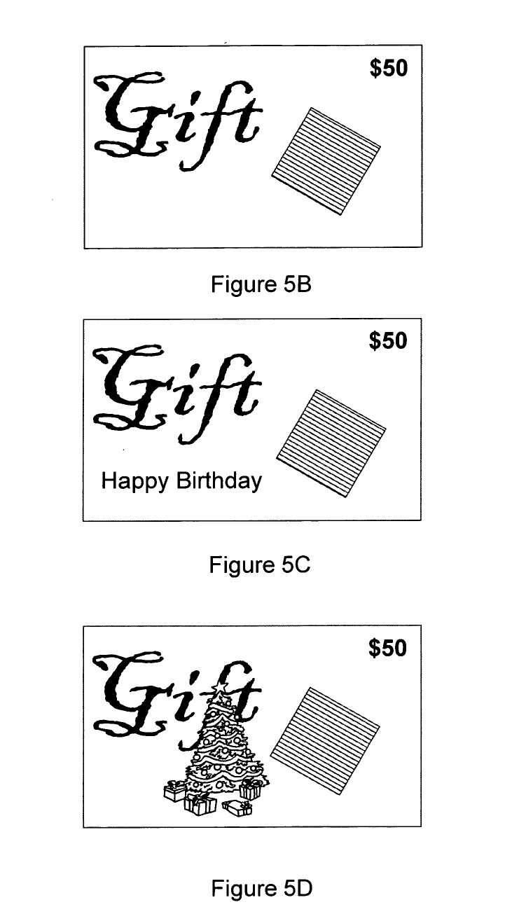

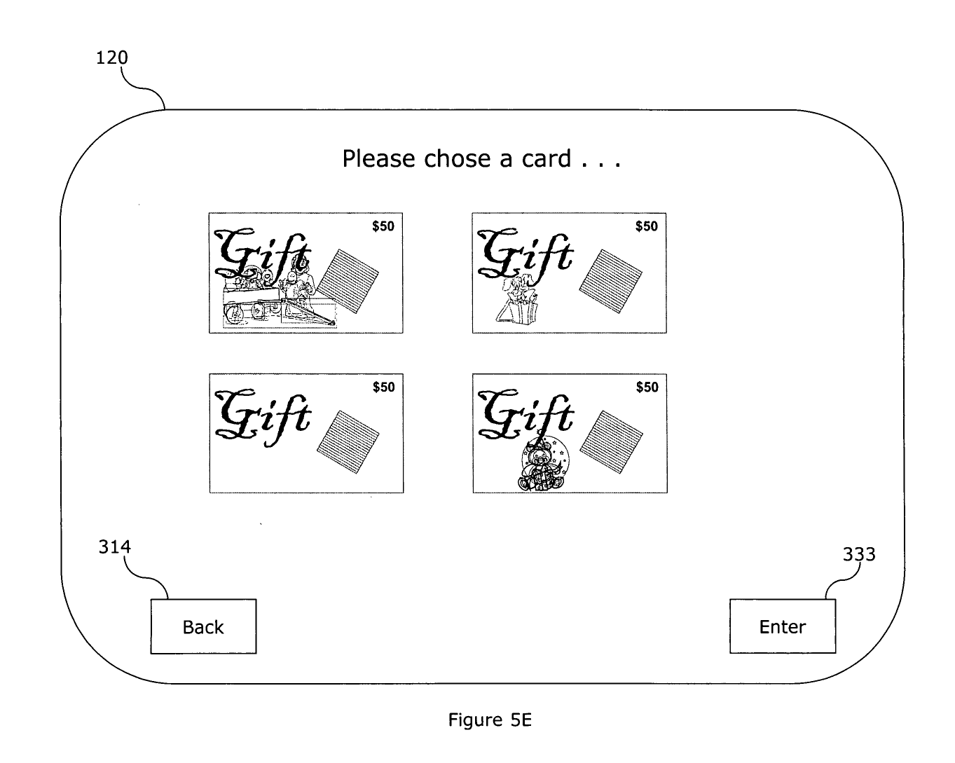

If the purchaser selects the next 317 screen button, he or she may be presented with a “standard card” template 500 and a “standard card sample” 503 as shown in FIG. 5A. The “standard card” template 500 may be a high resolution image of the card's content. It is contemplated that the standard card contains the retailer's “generic” graphic 505, and only the dollar amount 508 for the card will be chosen by the purchaser and set to the predetermined font, color, and location. The “generic” graphic 505 may be selected from a number of options presented to the purchaser. It may also be selected from answers previously presented to the purchaser, or new questions presented to the purchaser. For example, as shown in FIG. 5B the purchaser may be presented with a card that only has the retailer's name and logo. The purchaser may also be presented with a card that includes the retailer's name, logo and a graphic for a particular occasion 5C or time of year 5D. Furthermore, if the purchaser has entered information about the recipient, cards that match the recipient attributes may be displayed to the purchaser for selection as shown in FIG. 5E.

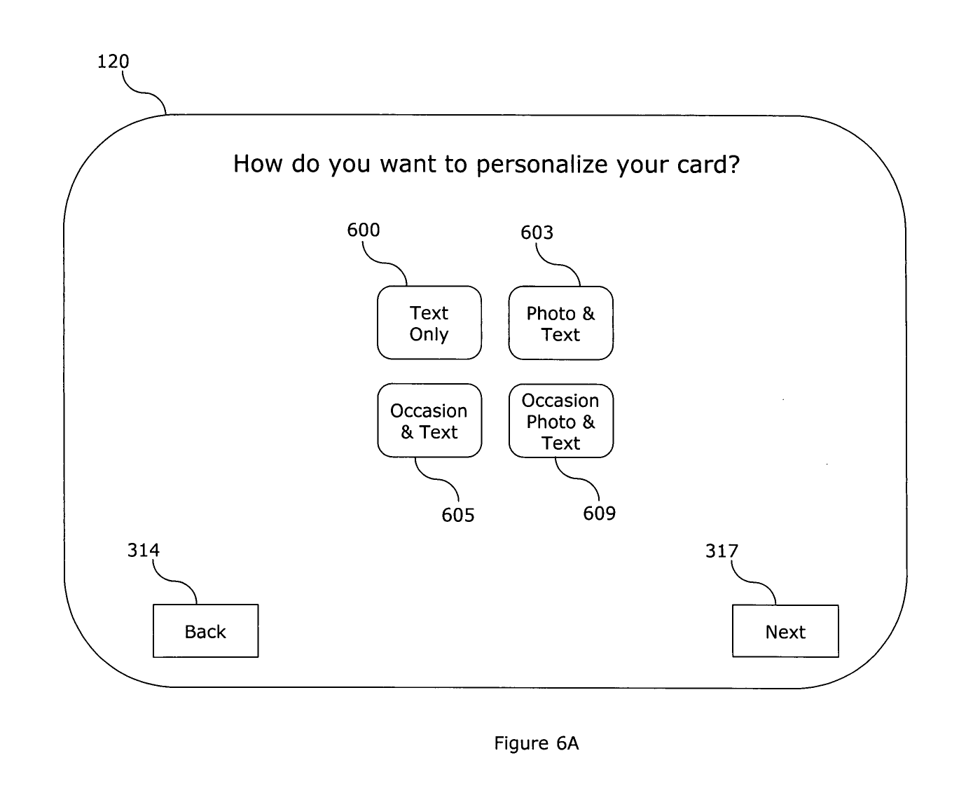

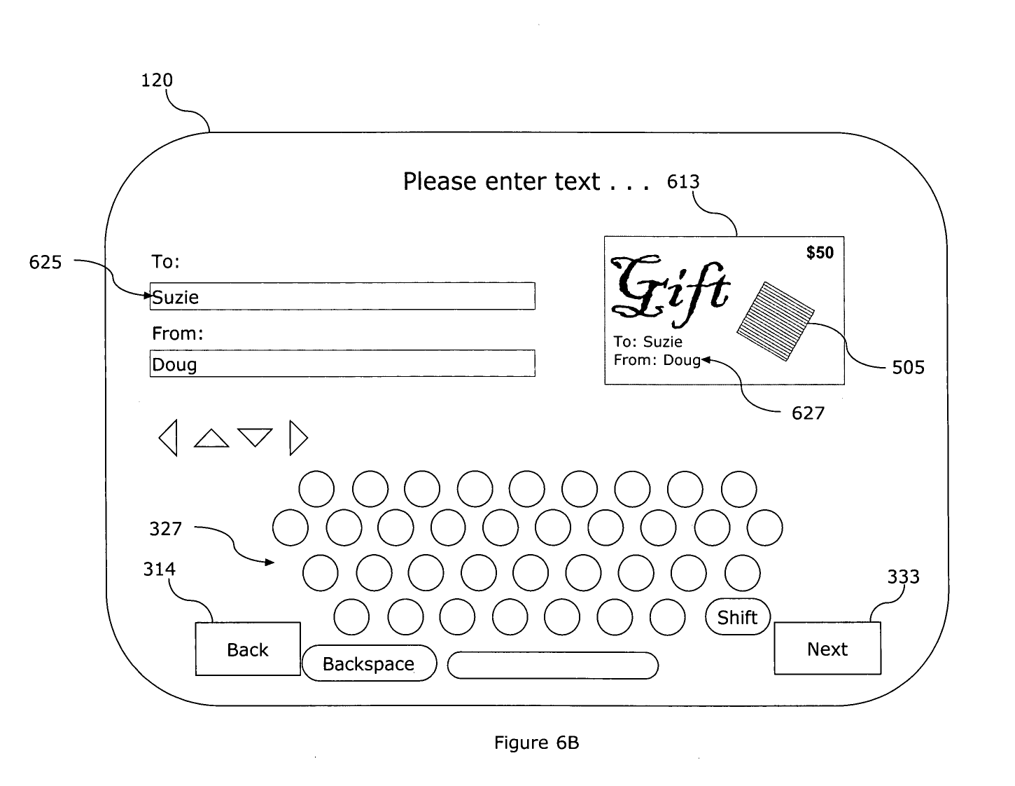

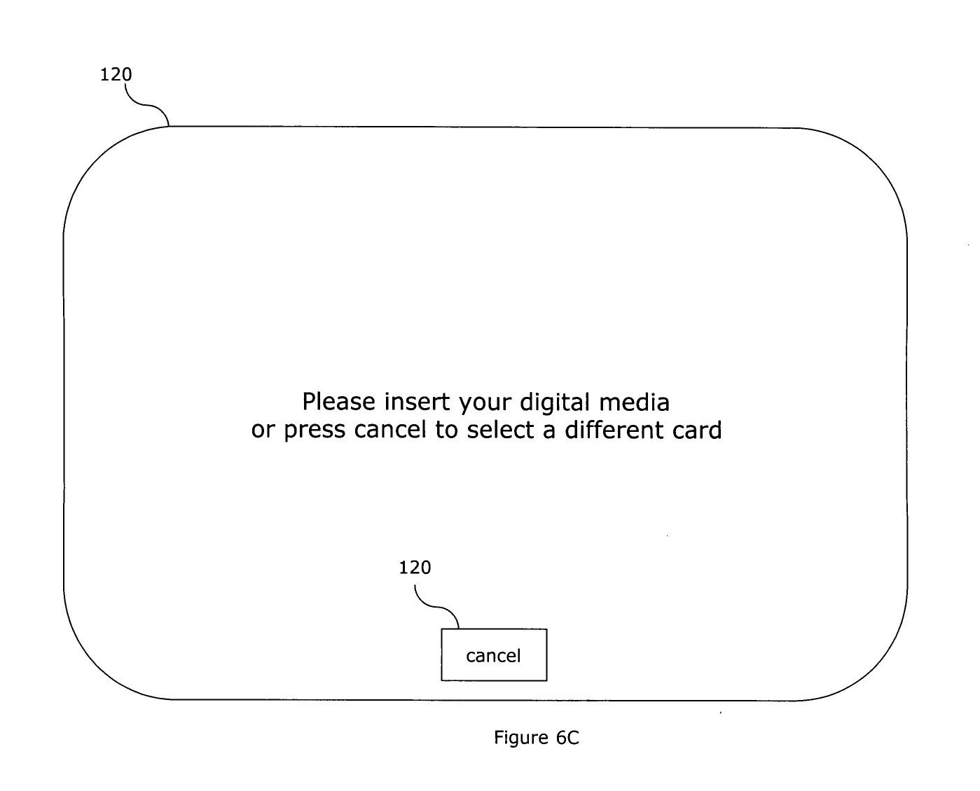

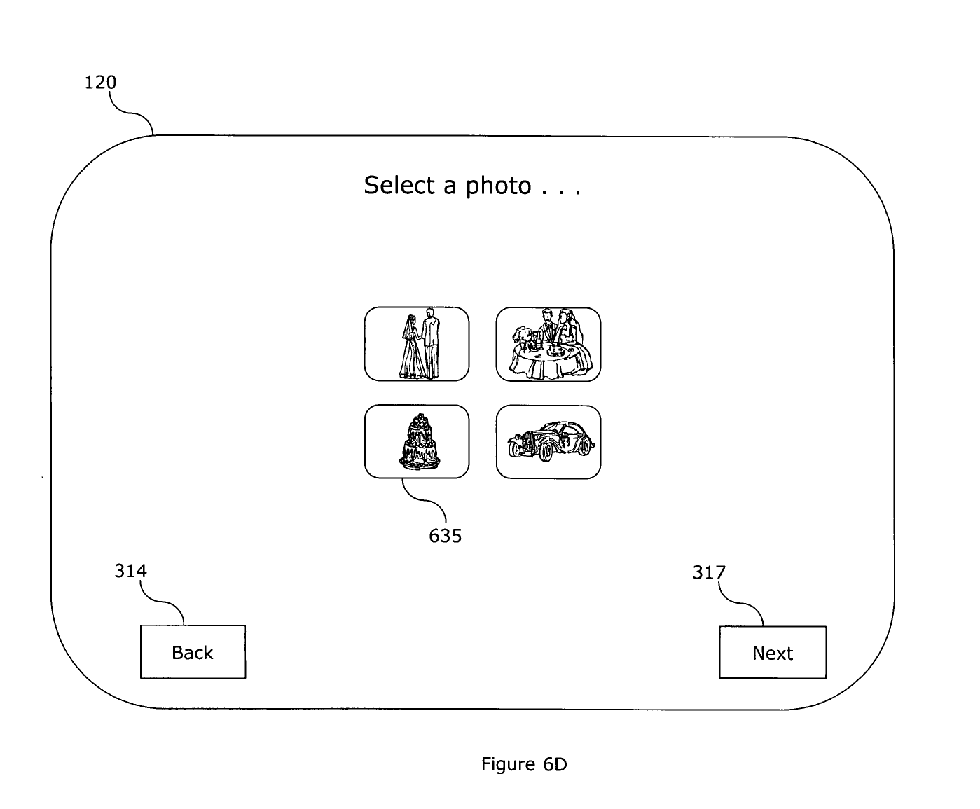

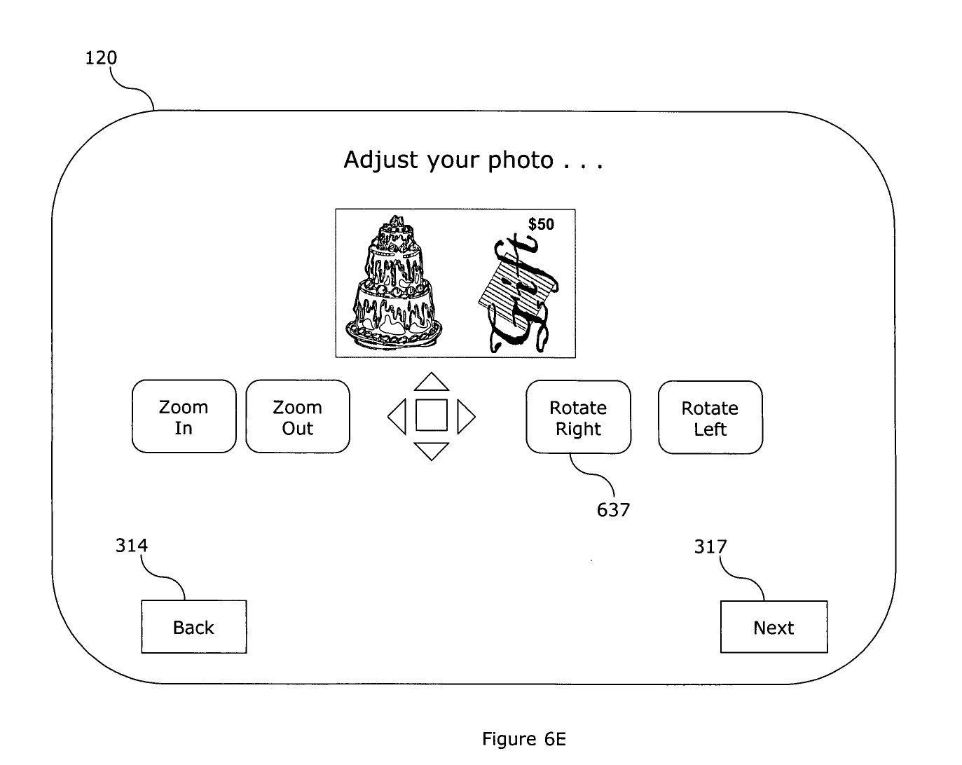

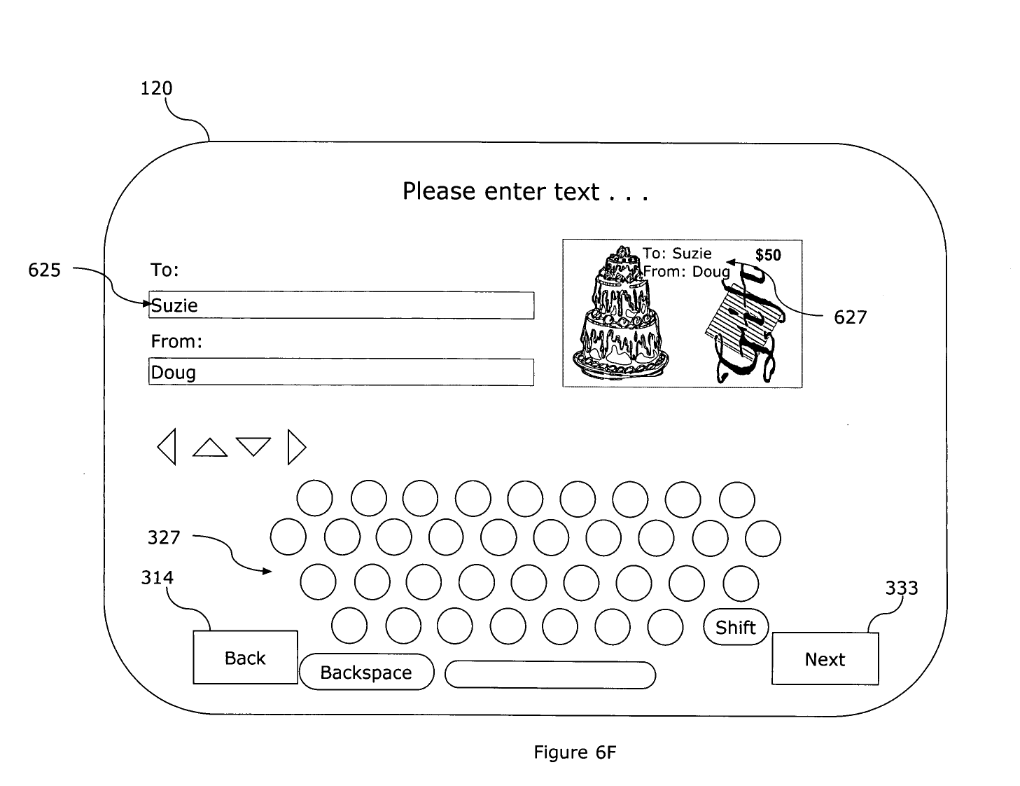

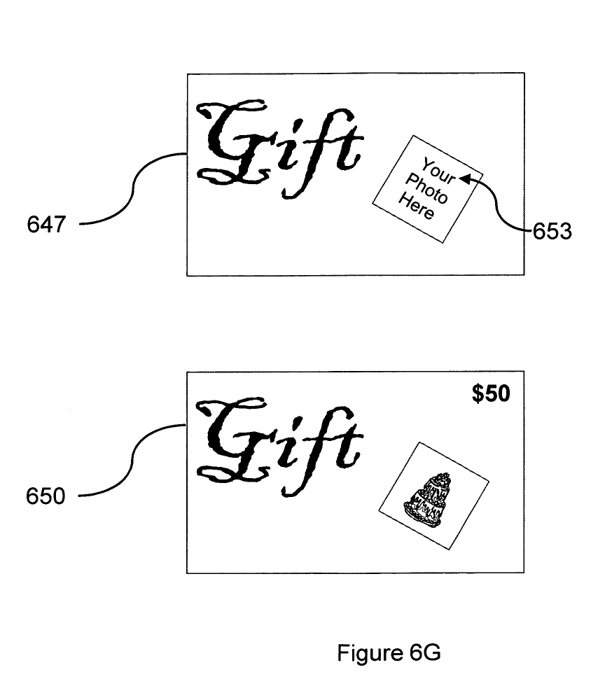

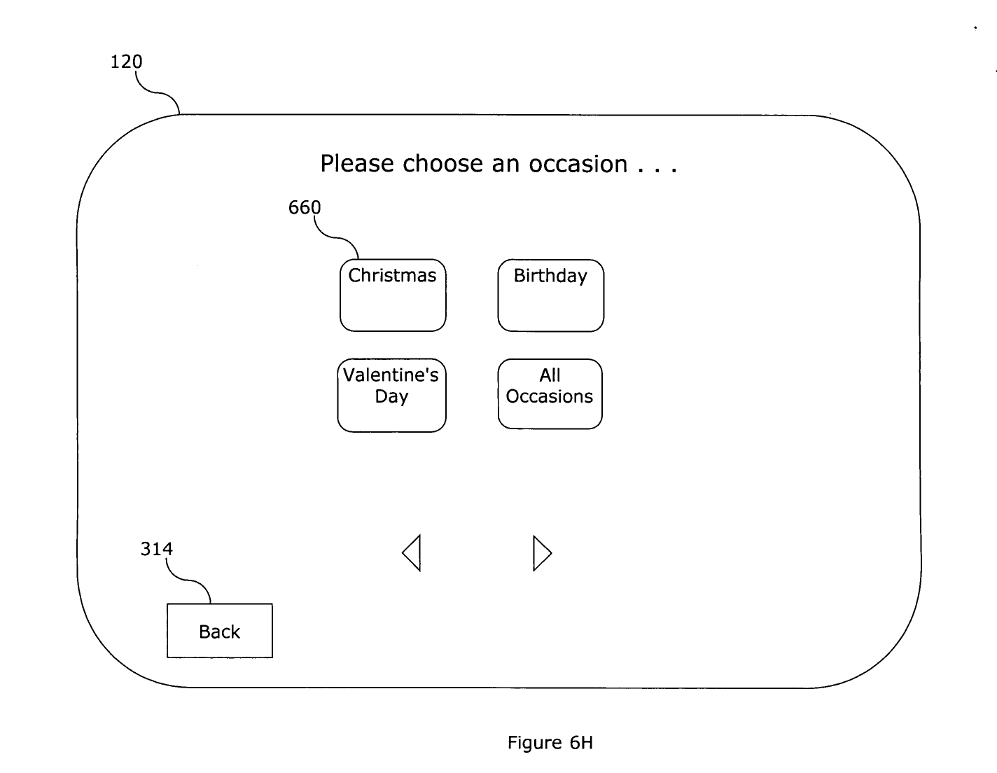

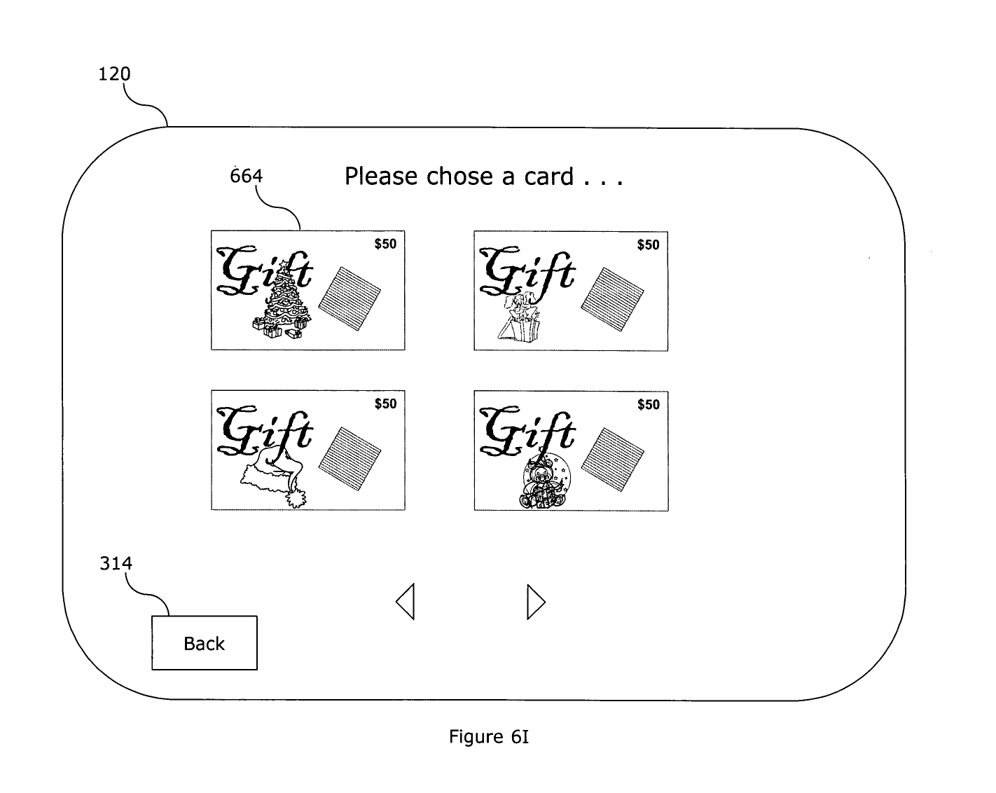

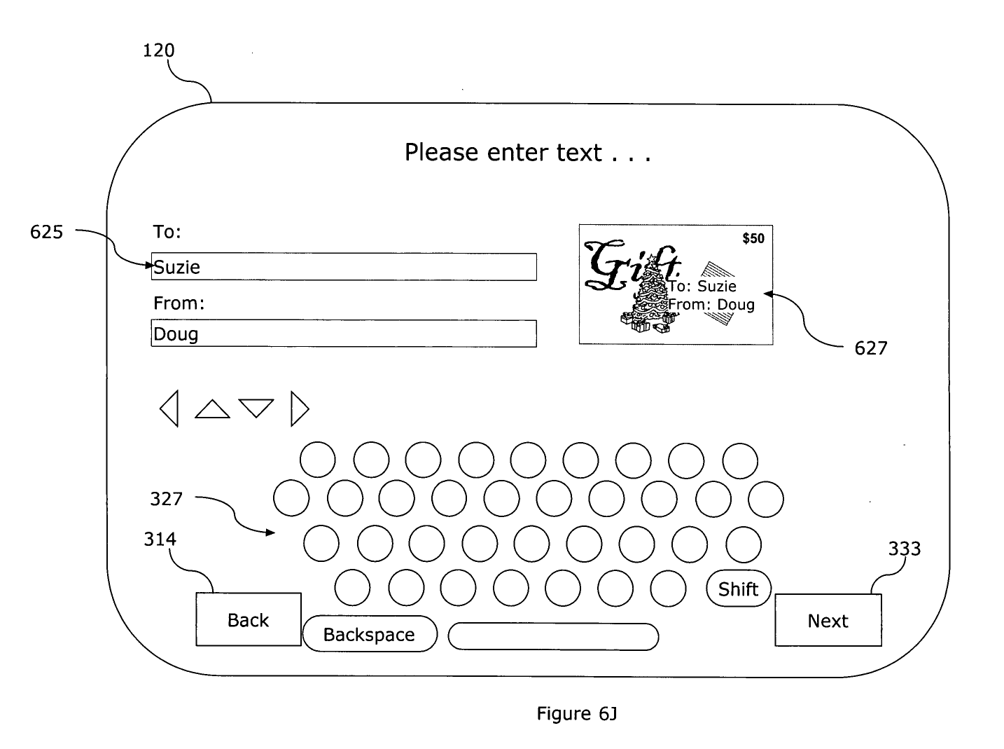

When a purchaser selects the “personalize card” button 430 from FIG. 4C, the wizard allows the purchaser to create, print, and activate personalized gift cards from national and local retailers. Gift cards can consist of graphics only, graphics with customized text, graphics with a photo or graphics with a photo and customized text. As shown in FIG. 6A, the purchaser may be presented with a text only button 600, a photo & text button 603, an occasion & text button 605, and an occasion, photo & text button 609. It is contemplated that other combinations and options may be presented to the purchaser.

As shown in FIG. 6B, after selection of the text only button 600, the purchaser will be presented with a “text only card” template 613 that contains the retailer's “generic” graphic 505, modified to accommodate user selected and/or user input text 625 set to a predetermined location 627 on the card. The user may utilize the keyboard 327 to enter text or select from a list of available text entries to be placed on the card. If a list of entries is made available, they may include messages such as “Happy Birthday,” “Happy Anniversary,” “Congratulations,” “Merry Christmas,” and other messages for different occasions. The purchaser may also be presented with at high resolution display of the selected card and a sample card with the text added by the purchaser. Different fonts and effects (e.g., drop shadows) may be utilized for the added text.

If the purchaser selects the photo and text button 603, he or she may be asked to insert the media containing the photo to be utilized into the appropriate media receptacle (flash memory reader, CD drive, USB port) as shown in FIG. 6C. The purchaser may also be presented with an option to select the location of the digital medium to be utilized. For example, the purchaser may be given the option to select a CD or a flash memory card. In some instances, the purchaser may be given the option to download the picture from a personal website address. Once the pictures are downloaded from the digital media device, the purchaser may be asked to select the desired picture 635 as shown in FIG. 6D. After the picture is selected, the purchaser may be allowed to modify the picture as shown in FIG. 6E. The wizard may provide buttons such as the rotate right button 637 and other commands to adjust the picture. In some embodiments, the purchaser may be able to modify the picture by, for example, removing blemishes, cropping, outlining, and other picture editing capabilities. Preferably, the retailer may choose any part of the card on which to place the photo, retailer logo and dollar amount (value). In some instances, the retailer may allow the purchaser to determine the size and location of the picture on the gift card. Any user added text is likewise placed on the card as shown in FIG. 6F. The wizard may also display a high resolution image 647 and a sample card 650 with all the content from the purchaser, as shown in FIG. 6G. The high resolution image 647 may include an alpha channel to be overwritten with the photo, which includes text stating “your photo here” 653. In some instances, it may be suggested that the text be placed at the bottom of the photo area and using special effects such as drop shadows. Preferably, when a photo is added to a gift card, the kiosk uses photo imaging and/or processing software to improve color and contrast (e.g., red-eye removal).

Preferably, another option provided to the purchaser is to personalize the card for an occasion and add text. Upon selection of the “occasion and text” button 605, the purchaser is given a number of occasion choices as shown in FIG. 6H. Each retailer may create their own unique, branded template for each occasion category, including by way of non-limiting example birthdays, Mother's Day, Valentine's Day, Christmas, Anniversary, “Get Well,” etc. When the purchaser selects an occasion button 660, the wizard provides a number of samples of the cards related to the same occasion (as shown in FIG. 6I) from which the purchaser may select their desired card 664. After the desired card 664 is selected, the purchaser may add text as illustrated in FIG. 6J.

In an additional embodiment of the invention, the three features previously described may be combined to provide an “occasion, photo and text” card, which provides the same features as the “occasion and text card,” but with the added feature of space for including a user's photo. It is contemplated that each gift card retailer may utilize additional templates for customizing the gift cards.

Preferably, the gift card templates, which provide the background for the card blanks, include a graphic image that is 1013×638 pixels, configured in horizontal (i.e., landscape) aspect, and stored as uncompressed TIFF or BMP files. As described previously, for the particular user-selected value assigned to each card, such value will also be printed on the card, and retailers will preferably specify font, font size, font color, and position on the card for such value indication. Further, each card template other than the “standard card” template will preferably receive data for font, size, color, location, alignment, and drop shadow of user-inputted text. The system preferably uses an XML file containing this retailer-provided data. Still further, card templates which require user-selected photos will preferably include an alpha channel mask in which the user's photo will be placed. On the alpha channel, the user image is preferably white on the alpha channel, and the processing software will allow the user to adjust their photo with the mask. Retailers may provide a high resolution graphic file for each card to be added to the kiosk, along with a sample graphic of how the retailer would like each finished card to look with the variables described above.

When printed, the gift cards are associated with a specific retail entity with which the intended recipient may spend the value stored on the card. Thus, during the gift card printing process, text and/or graphics associated with that intended retail entity are printed on the card. Gift card templates are stored in a database that is in communication with the processor, and provide full resolution graphics that may be imprinted on the gift card blanks during the purchase transaction.

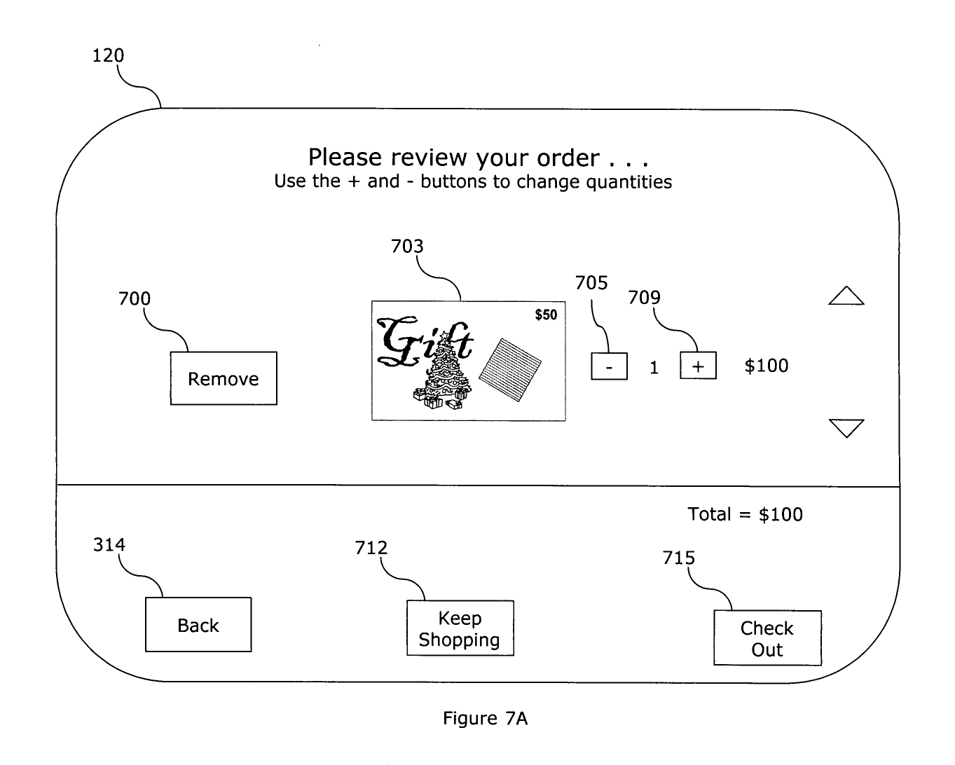

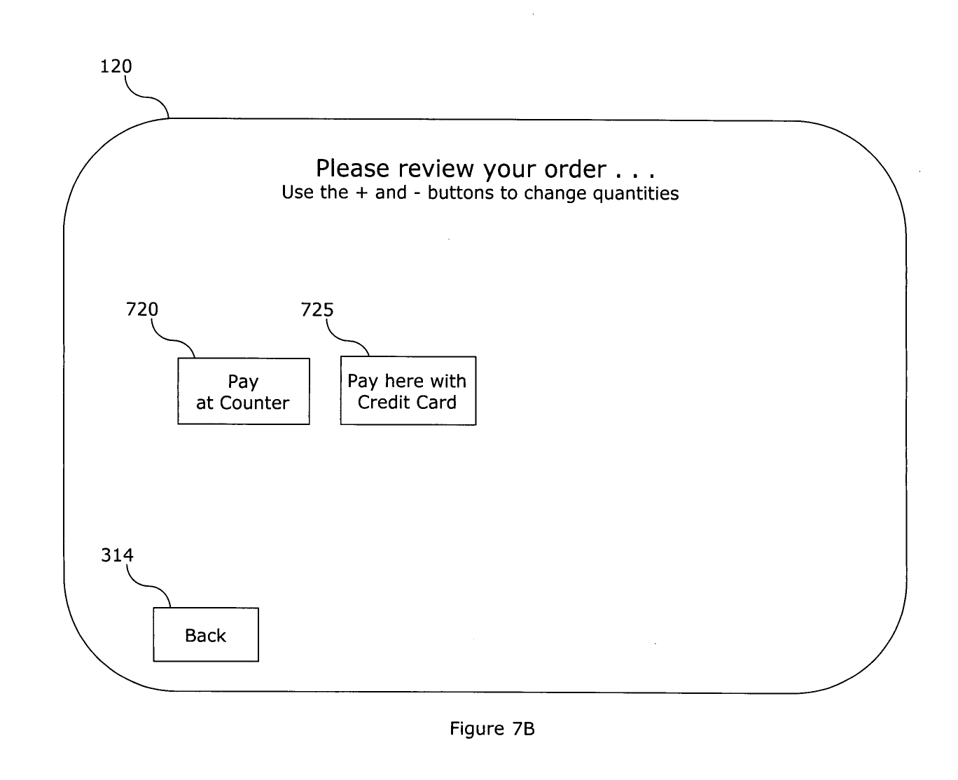

Final selection of the card leads the purchaser to the check out window as illustrated in FIG. 7A. The purchaser may utilize the remove button 700 to delete any unwanted cards 703. On the other hand, the purchaser may select the increase button 705 and the decrease button 709 to change the quantity of cards to be purchased. Additionally, the purchaser may be given the possibility of purchasing other cards by selecting a keep shopping button 712. Once the purchaser is ready to proceed to purchase the cards, he or she may select the check out button 715. The check out button 715 leads the costumer to the payment method screen as shown in FIG. 7B. The purchaser may be able to select a pay at the counter button 720 or a pay here with credit card button 725. It is also contemplated that if the kiosk is equipped with a cash reader, the purchaser may be allowed to pay with cash at the kiosk. Once the payment is processed, the card is printed and the purchaser may retrieve it from the kiosk or from the store's counter.

The computer processor executes software that controls the purchase and card activation transaction. Using that software, a card may print on one of preferably two separate card printers, a local printer at the kiosk or a network printer in a retail photo lab. The differentiation of what printer to use may be customized based upon what items are being printed. For example, if a customer chooses to print a picture or text on the card, the card may be printed at the network printer at the photo lab. This may provide extra security against the unacceptable use of profane images or text as well as copyright infringement. If the consumer, on the other hand, selects a “standard card,” that card may be printed on the local printer at the kiosk. In other embodiments of the present invention, the software may optionally provide a profanity filter that checks text input by the consumer against a list of profane words or phrases and keeps the user from entering unacceptable text on the cards. When the profanity filter is enabled, cards that incorporate user generated text may be printed at the local printer at the kiosk.

The kiosk can output the personalized gift card images to a card printer, which printer has the ability to encode the magnetic stripe on the card according to the specifications provided by the various gift card processing companies. In some embodiments of the present invention, the card printer includes an encoder. In other embodiments, the encoder is a separate structure that encodes the magnetic stripe before the card blank is passed to the card printer that prints the personalized card images onto the card blank.

As explained above, in order to provide added security, gift card blanks do not include any identification characteristics. Thus, magnetic stripe information must be acquired and added to the gift card during the purchase transaction. In a first step, the magnetic stripe information that identifies the card by its company is reserved on a database located either locally on the card station system, on a remote server hosted by a retailer or other entity, or directly from a gift card processor. More particularly, payment processors (e.g., a financial institution) issue and ultimately provide to retailers card numbers that uniquely identify each gift card (thus allowing the amounts associated with various cards to be tracked by the payment processors). The payment processors handle the creation of numbers and provide the financial backing of the gift cards. Those card numbers are preferably stored in a database in communication with the processor, and may simply be TXT files listing specific card numbers that are associated with the specific retailers for whom gift cards may be purchased from the gift card kiosk. When a new card is purchased from the kiosk, the software retrieves an available card number from the database for the selected retailer. In order to obtain and maintain available card numbers for issuance of new cards, a gift card kiosk operator may purchase card numbers from payment processors, which the operator may then sell to the retailers for whom gift cards may be purchased, or those retailers may purchase card numbers directly from the payment processors and simply relay that information to the gift card kiosk operator to populate the database. After a card number is retrieved from the database, the encoder writes the associated card number to the card (encoding that number on the magnetic stripe) during printing of the card. The card may or may not be imprinted with such card number; if imprinted, additional security may be maintained to ensure that unauthorized use of the card (e.g., by copying and using the card number in an online purchase) is prevented.

It is possible that at times there will be no available card numbers for a given retailer, which in turn would prevent the purchase of a card for such retailer. To prevent this scenario, a check on the availability of the cards for purchase may be handled in two ways. First, the software may periodically query the database using a heartbeat method to check on the availability of magnetic stripe data. If there is no available strip information (card numbers) for a particular card, the card is hidden in the software. Second, when a user selects a card, the software attempts to reserve the card in the database. If there are no available cards, the software gives the user a message informing them that the card is not available for purchase at this time. Likewise, if there are no available cards for a given retailer, the software may remove the card as an available option, and may inform the particular retailer that they are low or empty on card numbers and thus must purchase additional card numbers. Alternatively, the software may automatically initiate a purchase of additional card numbers from a payment processor, and in turn sell those card numbers to the retailer on an as-needed basis.

For card activation, each gift card kiosk essentially mimics a retailer's POS for pre-made cards. As each retailer typically has its own system in place for gift card activation from a POS, the instructions used to activate a card from such a traditional POS are provided by individual retailers to the gift card kiosk operator so that such activation protocols may be executed by the kiosk processor. Preferably, if the user session is terminated in the software prior to completion of the transaction, the card data is released back to its source.

Optionally, customized gift cards may likewise be purchased online but printed at the retail location at which the gift card kiosk is located. Each card is customized and purchased online using a retailer's website or a website associated with the gift card kiosk operator. The card may print remotely at a retail corporate printer, at a printer at the gift card kiosk operator's location, or at a local store. These cards may then either be picked up locally or shipped to the recipient. The kiosk also preferably collects payments by printing a receipt, which the consumer takes to the nearest cashier to pay for their order, or reads and processes the consumer's credit card for payment. Optionally, payment may also be received from cash through a cash reader on the kiosk.

Once the purchaser retrieves the card from the kiosk or the retail store's counter, the card is ready for use. The intended recipient may then utilize the card at any of the participating retail stores that accept the encoded gift card, which has been personalized for a particular gift card recipient.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for selecting gift cards comprising the steps of:
creating a database of available gift cards;
assigning at least one card attribute to each gift card in said database;
requesting at least one recipient attribute from a purchaser;
comparing said at least one recipient attribute to said card attributes of said gift cards in said database; and
presenting to the purchaser available gift cards whose card attributes match the recipient attributes provided by the purchaser.

2. The method for selecting gift cards of claim 1, wherein the recipient attributes are selected from the group consisting of age of an intended recipient, gender of an intended recipient, location of an intended recipient, and interests of an intended recipient.

3. The method for selecting gift cards of claim 1, further comprising the steps of:
creating a database of available retailers;
assigning retailer attributes to said available retailers;
comparing said at least one recipient attribute to said retailer attributes; and
presenting the purchaser with retailers whose retailer attributes match said recipient attributes.

4. The method for selecting gift cards of claim 1, further comprising the steps of: personalizing said gift cards.

5. The method for selecting gift cards of claim 4, wherein said step of personalizing said gift cards comprises the steps of:
requesting recipient information from said purchaser; and
adding said recipient information to a sample gift card selected by the purchaser.

6. The method for selecting gift cards of claim 5, wherein said recipient information comprises at least one of recipient's name, purchaser's name, and purchaser created text.

7. The method for selecting gift cards of claim 1, further comprising the step of:
receiving a picture from the purchaser and adding said picture to the gift card.

8. The method for selecting a gift card of claim 7, wherein said picture is retrieved from a digital media storage device.

9. The method for selecting gift cards of claim 1, further comprising the step of receiving a selection from the purchaser of an occasion, and presenting to the purchaser available gift cards whose card attributes match the selected occasion.

10. A software program implemented on a processor readable medium including instructions performed on a data processor for selecting gift cards, comprising:
instructions for creating a database of available gift cards;
instructions for assigning at least one card attribute to each gift card in said database;
instructions for requesting at least one recipient attribute from a purchaser;
instructions for comparing said at least one recipient attribute to said card attributes of said gift cards in said database; and
instructions for presenting to the purchaser available gift cards whose card attributes match the recipient attributes provided by the purchaser.

11. The software program of claim 10, wherein the recipient attributes are selected from the group consisting of age of an intended recipient, gender of an intended recipient, location of an intended recipient, and interests of an intended recipient.

12. The software program of claim 10, further comprising:
instructions for creating a database of available retailers;
instructions for assigning retailer attributes to said available retailers;
instructions for comparing said at least one recipient attribute to said retailer attributes; and
instructions for presenting the purchaser with retailers whose retailer attributes match said recipient attributes.

13. The software program of claim 10, further comprising:
instructions for personalizing said gift cards.

14. The software program of claim 13, wherein said instructions for personalizing said gift cards comprises:
instructions for requesting recipient information from said purchaser; and
instructions for adding said recipient information to a sample gift card selected by the purchaser.

15. The software program of claim 14, wherein said recipient information comprises at least one of recipient's name, purchaser's name, and purchaser created text.

16. The software program of claim 14, further comprising:
instructions for receiving a picture from the purchaser and adding said picture to the gift card.

17. The software program of claim 16, wherein said picture is retrieved from a digital media storage device.

18. The software program of claim 9, further comprising:
Instructions for receiving a selection from the purchaser of an occasion, and presenting to the purchaser available gift cards whose card attributes match the selected occasion.

19. A system for selecting personalized gift cards, comprising:
a gift card kiosk; and
a data processor for selecting gift cards, comprising:
instructions for creating a database of available gift cards;
instructions for assigning at least one card attribute to each gift card in said database;
instructions for requesting at least one recipient attribute from a purchaser;
instructions for comparing said at least one recipient attribute to said card attribute of said gift cards in said database; and
instructions for presenting to the purchaser available gift cards whose card attributes match the recipient attributes provided by the purchaser.

20. The system of claim 19, wherein the recipient attributes are selected from the group consisting of age of an intended recipient, gender of an intended recipient, location of an intended recipient, and interests of an intended recipient.

21. The system of claim 19, said data processor further comprising:
instructions for creating a database of available retailers;
instructions for assigning retailer attributes to said available retailers;
instructions for comparing said at least one recipient attribute to said retailer attributes; and
instructions for presenting the purchaser with retailers whose retailer attributes match said recipient attributes.

22. The system of claim 19, said data processor further comprising:
instructions for personalizing said gift cards.

23. The system of claim 22, wherein said instructions for personalizing said gift cards comprises:
instructions for requesting recipient information from said purchaser; and
instructions for adding said recipient information to a sample gift card selected by the purchaser.

24. The system of claim 23, wherein said recipient information comprises at least one of recipient's name, purchaser's name, and purchaser created text.

25. The system of claim 23, said data processor further comprising:
instructions for receiving a picture from the purchaser and adding said picture to the gift card.

26. The system of claim 25, wherein said picture is retrieved from a digital media storage device.

27. The system of claim 19, said data processor further comprising:
Instructions for receiving a selection from the purchaser of an occasion, and presenting to the purchaser available gift cards whose card attributes match the selected occasion.
